(19) United States
(12) Patent Application Publication
(10) Pub. No.: US 2025/0296436 A1
(43) Pub. Date: Sep. 25, 2025

(54) TRAILER AND CAMPER POP OUT OR DEPLOYED SLIDER DETECTION

(71) Applicant: Ford Global Technologies, LLC, Dearborn, MI (US)

(72) Inventors: Keith Weston, Canton, MI (US); Brendan Diamond, Naples, FL (US); John Robert Van Wiemeersch, Novi, MI (US); Stuart C. Salter, White Lake, MI (US); Rudi Todd Ansbacher, Westland, MI (US)

(73) Assignee: Ford Global Technologies, LLC, Dearborn, MI (US)

(21) Appl. No.: 18/615,551

(22) Filed: Mar. 25, 2024

(51) Int. Cl. B60K 28/10; B60P 3/34; B60R 1/26; G06V 20/56

(52) U.S. Cl. CPC B60K 28/10; B60R 1/26; G06V 20/56; B60P 3/34

(57) ABSTRACT

A motor vehicle includes at least one sensor that is configured to capture trailer data corresponding to a trailer that is hitched to the vehicle. The motor vehicle is configured to utilize a user interface to provide a user with trailer data whereby a user can identify towable and/or non-towable trailer form factors. The vehicle may be configured to utilize image recognition to recognize a trailer image in which a deployable structure of the trailer is not in a stowed position based, at least in part, on the trailer data.

### FIELD OF THE DISCLOSURE

The present disclosure generally relates to a vehicle, and more particularly to a vehicle that is capable of towing a trailer.

### BACKGROUND OF THE DISCLOSURE

Motor vehicles may include a trailer hitch whereby the motor vehicle can tow a trailer. Known trailers may include one or more deployable structures that can be shifted between deployed and stowed configurations. For example, camper trailers may include slide out features that can be used to increase space inside the trailer when camping. Trailers may also include stairs that may be deployed to assist users entering the trailer, awnings that can be shifted between deployed and retracted positions, and other such features.

### SUMMARY OF THE DISCLOSURE

An aspect of the present disclosure is a motor vehicle that is adapted for towing a trailer having at least one deployable structure that extends and retracts from a side of the trailer between deployed and retracted positions. The motor vehicle includes at least one sensor that is capable of sensing a position of a deployable structure of a trailer. The sensor may comprise a rearview camera system that is configured to capture trailer data corresponding to at least a portion of a trailer when the trailer is hitched to the vehicle. The vehicle further includes a user interface that is configured to permit a user to input information corresponding to the retracted and deployed positions of the at least one deployable structure based on an image of a trailer or other information that is generated using the trailer data. The vehicle is configured to: 1) utilize the trailer data to determine if the at least one deployable structure of the trailer is at least partially deployed from the retracted position, and 2) if the at least one deployable structure of the trailer is at least partially deployed, generate an operator alert and/or modify vehicle operation and/or restrict movement of the vehicle. The at least one sensor may optionally comprise a rearview camera.

Embodiments of the first aspect of the present disclosure can include any one or a combination of the following features:
The system may be configured to store a first form factor corresponding to at least one set of trailer data (e.g. an image) from the at least one rearview camera, wherein the first form factor may correspond to a trailer configuration in which the at least one deployable structure is not deployed.
The motor vehicle may be configured to detect a trailer hitched to the vehicle, and the motor vehicle may be configured to utilize the user interface to prompt a user to identify a second form factor (e.g. using an image generated from a data set) corresponding to a trailer configuration in which at least one deployable structure of the trailer is in a deployed position.
The motor vehicle may be configured to use image recognition to detect deviations from the first form factor.
The motor vehicle may be configured to detect deviations from the first form factor while the motor vehicle is stationary.
The motor vehicle may be configured to detect deviations from the first form factor while the motor vehicle is moving.
The motor vehicle may be configured to, at least initially, restrict and/or prevent movement of the motor vehicle if deviations from the first form factor are detected.
The motor vehicle may be configured to permit movement of the motor vehicle if an override is activated after deviations from the first form factor are detected.
The motor vehicle may be configured to detect deviations from the first form factor while the motor vehicle is moving.
The user interface may be configured to display images of at least a portion a trailer hitched to the vehicle, whereby a user can identify images of the trailer in which at least one deployable structure of the trailer is at least partially deployed.
The user interface may be configured to display images of a trailer hitched to the vehicle, whereby a user can identify images of the trailer in which the at least one deployable structure is in a retracted position.
The vehicle may be configured to store a profile of a trailer based, at least in part, on information input by a user concerning 1) images in which the at least one deployable structure is at least partially deployed, and 2) images in which the at least one deployable structure is in a retracted position.
The vehicle may be configured to 1) determine if a trailer is hitched to the vehicle, and 2) determine if a profile of the trailer has been stored.
The vehicle may be configured to prompt a user to input information concerning retracted and/or deployed configurations of at least one deployable structure if a profile of the trailer has not been stored.
The vehicle may be configured to retrieve a profile of the trailer if a profile of the trailer has been stored.
The vehicle may be configured to restrict vehicle movement by limiting a speed of the vehicle if the at least one deployable structure is not in the retracted position, and the vehicle may include a user override feature that permits a user to at least partially modify the restriction of vehicle movement.
The vehicle may be configured to prevent movement of the vehicle if the at least one deployable structure is not in the retracted position.

Another aspect of the present disclosure is a motor vehicle that is capable of towing a trailer having a deployable structure. The motor vehicle includes at least one sensor that is configured to capture trailer data for a trailer that is hitched to the vehicle. The trailer data may include a first set of trailer data comprising a trailer in which a deployable structure of the trailer is hitched to the vehicle, in which the deployable structure is in a stowed position. The trailer data may further include a second set of trailer data comprising a trailer that is hitched to the vehicle, in which the deployable structure is in a deployed position. The user interface may be configured to permit a user to identify the second set of trailer data as corresponding to a non-towable trailer form factor. The vehicle may be configured to utilize a data recognition feature to recognize trailer data for a trailer configuration in which a deployable structure of the trailer is not in a stowed position based, at least in part, on at least one of the first and second sets of trailer data.
The motor vehicle may include a system that is configured to increase and/or decrease a speed of the vehicle, and the motor vehicle may be configured to restrict a speed of the motor vehicle if a deviation from the first set of trailer data is detected by the motor vehicle.
The first and second sets of trailer data may comprise images of a trailer that are displayed on the user interface.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a partially schematic top plan view of a motor vehicle and trailer;

FIG. 2 is a partially fragmentary isometric view of a Human Machine Interface (HMI);

FIG. 3 is a flow chart showing an aspect of the present disclosure;

FIG. 4A is a flow chart showing an aspect of the present disclosure;

FIG. 4B is a flow chart showing an aspect of the present disclosure;

FIG. 5 is a partially schematic view of an HMI showing an image from a rearview camera;

FIG. 6 is an enlarged view of a portion of the image of FIG. 5;

FIG. 7 is a partially schematic view of an HMI showing an image from a rearview camera;

FIG. 8 is an enlarged view of a portion of the image of FIG. 7;

FIG. 9 is a partially schematic view of an HMI showing an image from a rearview camera; and

FIG. 10 is a partially schematic view of an HMI showing an image from a rearview camera, wherein deployed trailer features are surrounded by lines.

### DETAILED DESCRIPTION OF THE PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

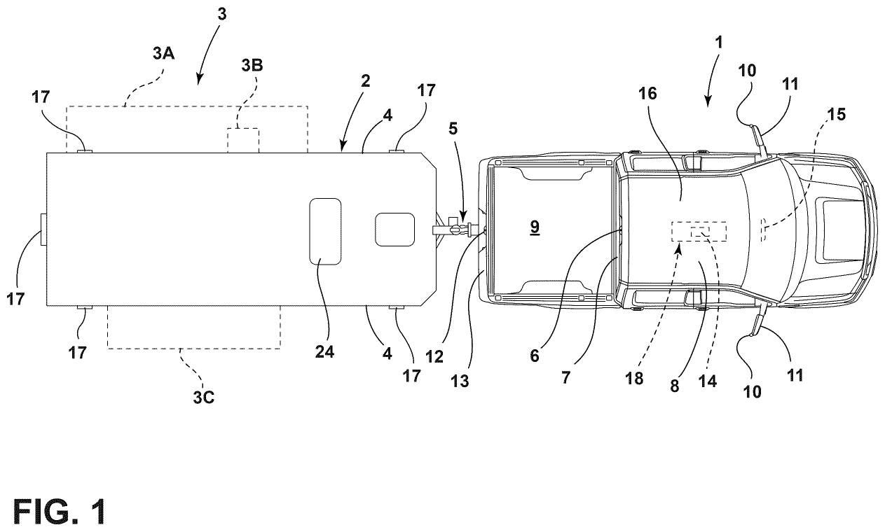

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a motor vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the terms “or” and “and/or,” when used in a list of two or more items, means that any one of the listed items can be employed by itself or any combination of two or more of the listed items, can be employed. For example, if a composition or device is described as containing or comprising components A, B, or C, the composition or device can contain (include) A alone; B alone; C alone; A and B in combination; A and C in combination; B and C in combination; or A, B, and C in combination. If a composition or device is described as containing or comprising components A and/or B and/or C, the composition or device can contain (include) A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” “including” or any other variation thereof, are intended to cover a non-exclusive inclusion, such that a process, method, article, or apparatus that includes or comprises a list of elements does not include only those elements but may include other elements not expressly listed or inherent to such process, method, article, or apparatus. An element proceeded by “comprises . . . a” or “includes . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

With reference to FIG. 1, a motor vehicle such as a pickup truck 1 is adapted to tow a trailer 2 having at least one deployable structure 3 which may comprise an awning 3A, steps 3B, or a slide out unit 3C. Although the present disclosure is not limited to a specific trailer, trailer 2 may comprise, for example, a hitch-mounted trailer (or a fifth wheel trailer) that is used for camping or the like, whereby the deployable structures 3A-3C may be deployed when the trailer 2 is stationary at a campsite. The deployable structures 3A-3C are configured to extend and retract from one or both sides 4 or the rear of trailer 2.

Truck 1 includes a sensor system 14 which may comprise one or more of a camera system, a radar system, LiDAR, ultrasonic sensors that are capable of collecting data concerning a position of one or more deployable structures of trailer 2. It will be understood that one or more sensors 14 may be positioned at various locations on truck 1, and the present disclosure is not limited to the schematic depiction of FIG. 1. In the illustrated example, truck 1 includes at least one rearview camera that is configured to capture images of at least a portion of trailer 2 when the trailer 2 is hitched to motor vehicle 1 by hitch 5. The camera may comprise a bed camera 6 that is mounted to a rear side 7 of a cab 8 of truck 1 above a bed 9 of truck 1. Camera 6 may comprise, for example, a component of a Center High Mounted Stop Lamp (CHMSL) assembly. Truck 1 may also include cameras 10 that are mounted to rearview mirrors 11. Truck 1 may also include a rearview camera 12 on a rear side 13 of truck 1. In addition or alternatively, truck 1 may include cameras on door handles of truck 1 and/or cameras mounted on B-pillars of truck 1. The handle and B-pillar cameras may optionally comprise “360” cameras having a wide field of view (e.g. about 180 degrees whereby the cameras are able to capture images of deployable structures of trailer 2 (e.g. deployable structures that deploy from a side or rear of trailer 2) that may not be visible to other cameras of truck 1. For example, cameras 10 may comprise side view cameras having a wide field of view (e.g. 180 degrees or more) whereby the cameras 10 capture images to the sides of truck 1, to the front of truck 1, and to the rear of truck 1. In general, the cameras may optionally comprise a 360-degree camera system including, for example, a rear view camera, a front view camera, and side view cameras that are capable of capturing images around truck 1 in all directions. Trailer 2 may include sensors 17 that may be configured to communicate with truck 1. Sensors 17 may comprise cameras, position sensors, or the like. It will be understood that FIG. 1 is schematic in nature. For example, trailer 2 may include position sensors that communicate a position of one or more deployable structures 3 to truck 1. The sensors may comprise binary switches that signal when a deployable structure is fully retracted and/or fully deployed. Linear sensors that defeat a relative position of a deployable structure and communication the position to truck 1 may also be utilized. The position of the deployable structure may then be cross-checked with road dimensions by truck 1. Truck 1 may be configured to notify a user if a deployable structure is partially or fully deployed in a manner that does not meet predefined criteria regarding, for example, maximum trailer width or other suitable criteria.

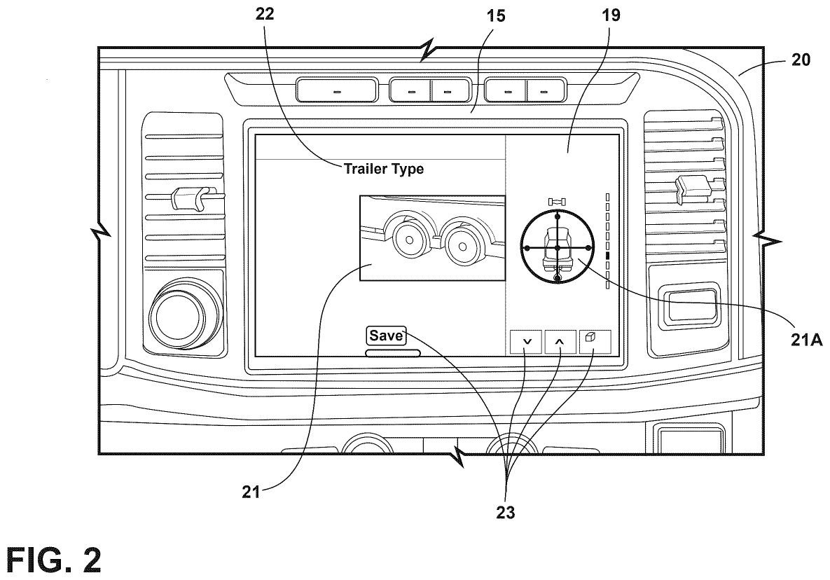

Truck 1 further includes a Human Machine Interface (HMI) or user interface 15 that is configured to permit a user to input information corresponding to retracted and deployed positions of the at least one deployable structure 3A-3C based, at least in part, on images of trailer 2 that are captured by at least one of the rearview cameras 6, 10, 12 and/or sensor(s) 17. As discussed in more detail below, user interface 15 may be operably connected to a vehicle control system 18. User interface 15 may optionally comprise a touchscreen device (FIG. 2) that is accessible to a user in the interior space 16 of cab 8 of truck 1. The user interface may comprise virtually any device (e.g. audio and/or optical) that is capable of communicating with a user and/or providing user inputs. The user interface may also comprise a smartphone fob, or other portable device either by itself or in combination with a touchscreen or other device that is mounted in truck 1.

The truck 1 is configured to utilize data which may correspond to images from the at least one rearview camera (e.g. one or more of cameras 6, 10, 12) (or sensor(s) 17) to determine if the at least one deployable structure (e.g. one or more of deployable structures 3A-3C) of the trailer 2 is at least partially deployed from the retracted position. The vehicle is also configured to generate an operator (user) alert and/or modify vehicle operation and/or restrict movement of truck 1 if the trailer 2 is not in a towable configuration (e.g. at least one deployable structure 3A-3C of the trailer 2 is at least partially deployed). It will be understood that the deployable structures 3A-3C are merely examples of deployable trailer structures, and trailer 2 may include virtually any deployable structure or structures. Also, the vehicle (e.g. truck 1) may be configured to detect items 14 that are improperly positioned on trailer 2, or to detect movement of one or more items 14, and the truck 1 may generate an operator alert and/or modify or restrict vehicle operation if the vehicle determines that an item 14 has caused trailer 2 to be in a non-towable configuration.

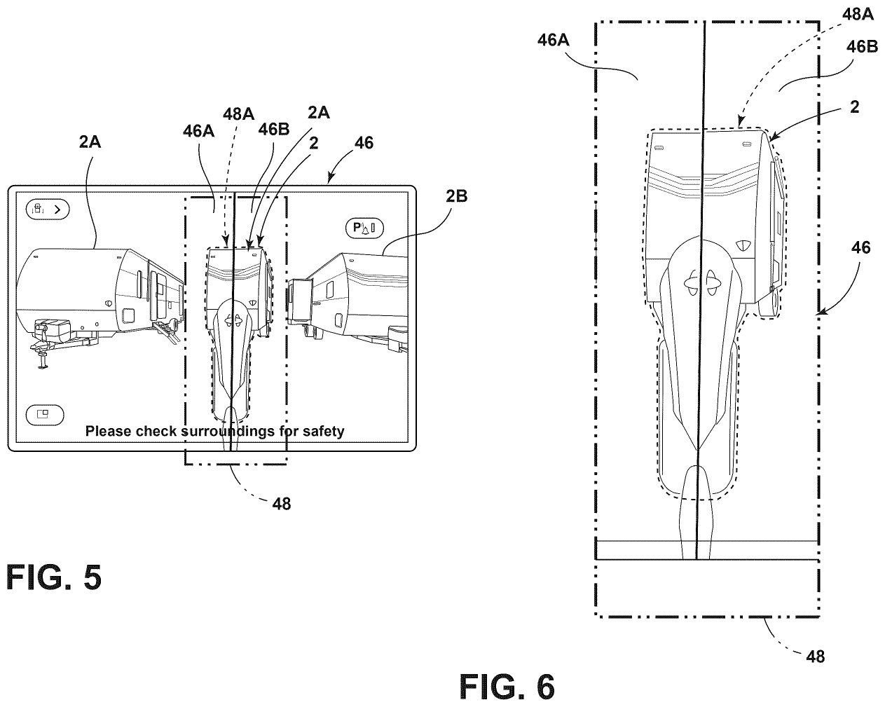

With reference to FIG. 2, user interface 15 may comprise an HMI such as a touch screen 19 that is configured to display one or more images 21, text 22, and user touch inputs 23. Images 21 and/or 21A may comprise schematic images and/or text 22 that provides an interactive user interface. As discussed below in connection with FIGS. 5-10, images 21, 21A etc. may comprise images of a trailer 2 that are captured utilizing one or more of the cameras 6, 10, and 12 and/or sensors 17. The images may, optionally, comprise computer generated images based on data from other sensors 14 and/or sensors 17, which may comprise one or more of radar, LiDAR, ultrasonic sensors, and/or other sensors capable of detecting trailer 2 and/or deployable structures in deployed and/or stored positions. Also, the vehicle (e.g. truck 1) may be configured to generate plan view images of trailer 2 and/or deployable trailer structures in deployed and/or stored positions based on data from cameras and/or other sensors 14 and/or sensors 17.

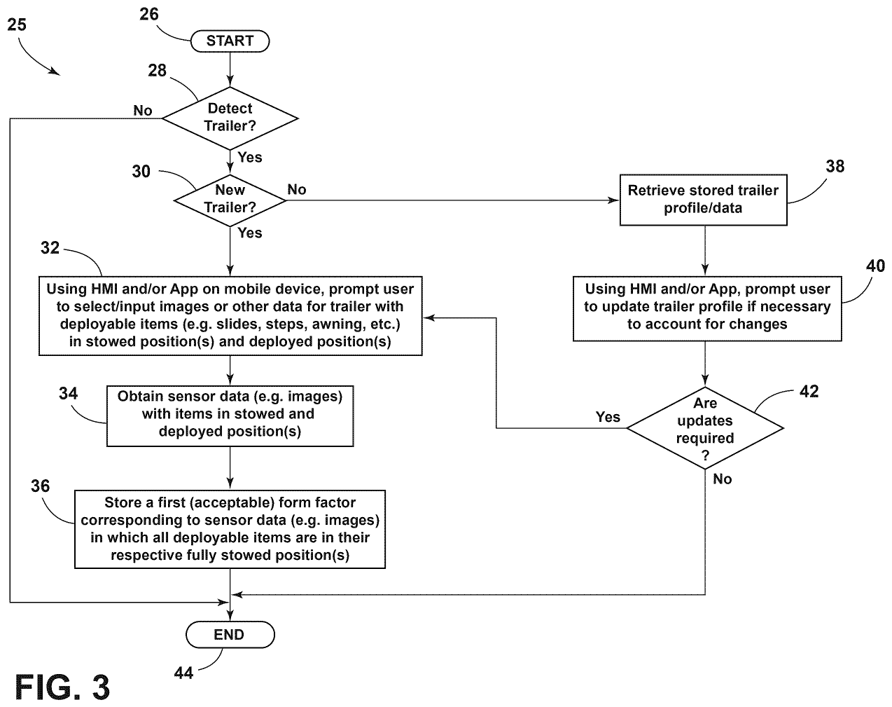

With further reference to FIG. 3, truck 1 may be configured to implement a process 25 at vehicle startup. Startup process 25 may be implemented utilizing, for example, user interface 15 and control system 18 of truck 1. Following vehicle startup at 26, the vehicle (e.g. truck 1) may detect a trailer 2 at step 28. If a trailer 2 is not detected at step 28, startup process ends at 44. However, if a trailer is detected at step 28, at step 30 the vehicle determines if a detected trailer is a new trailer. The vehicle (e.g. truck 1) may be configured to store data for one or more trailers 2, and step 30 may involve comparing the detected trailer to the stored data for known trailers to determine if the trailer is a “new” trailer such that no data for the trailer is stored. The determination at step 30 may include, for example, comparing images of the trailer 2 from one or more of the cameras to stored images for known trailers, and image recognition may be utilized to determine if the trailer is a new trailer. Alternatively, other trailer identification techniques may be utilized to determine if trailer 2 is a known trailer. For example, trailer 2 may be electrically interconnected with truck 1 by electrical and/or communication lines, and a unique trailer identification code or number may be communicated from trailer 2 to truck 1. Truck 1 may be configured to compare the identification code to existing identification codes stored by vehicle 1 to determine if the trailer 2 is a new trailer. It will be understood that various trailer identification devices and processes are known.

If a new trailer is detected at step 30, the process continues to step 32. A user is then prompted to select or input images or other data for the trailer 2. The user may be prompted utilizing an HMI user interface 15 and/or an app on a smartphone, computer, or other suitable device. Step 32 may include, for example, asking a user if trailer 2 has one or more deployable structures, and the system may be configured to prompt a user to provide additional input concerning the type, size, and number of deployable structures.

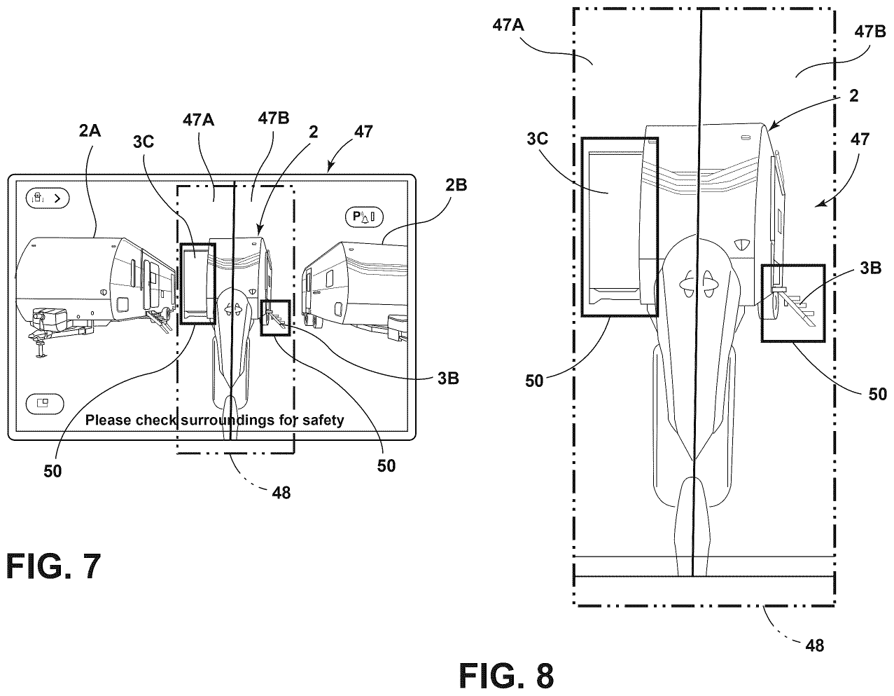

At step 34, the vehicle obtains sensor data for trailer 2. For example, with reference to FIGS. 5 and 6, the sensor data may comprise image data, and an image 46 may be displayed on user interface 15. In the illustrated example, image 46 comprises an image of trailer 2 having first and second regions 46A and 46B captured by rearview mirror cameras 10. However, the sensor data may comprise virtually any sensor data from sensors on vehicle 1 and/or trailer 2. User interface 15 may optionally generate a border 48 extending around trailer 2 to identify deployable structures and/or features that the vehicle identifies a possible deployable feature. For example, the vehicle may be configured to identify trailer 2 and generate a border 48 extending around trailer 2 whereby adjacent objects such as trailers 2A and 2B are outside of the border 48. In general, the vehicle may utilize an image recognition feature to identify a trailer 2 that is directly behind vehicle 1 and exclude other trailers or objects that are outside of the border 48. The system (vehicle) may be configured to prompt a user to identify the trailer 2 within the border 48, and specify if the deployable structures are stowed or deployed in the images 46A and 46B. As discussed in more detail below, the vehicle may be configured to store images or other data corresponding to the non-deployed (towable) trailer configuration (form factor) of FIGS. 5-6. For example, the vehicle may prompt a user to touch the screen inside border 48 to confirm that a trailer 2 is inside border 48. Alternatively, a border 48A that extends closely around an edge 2A of the image of trailer 2 may be generated, and a prompt may be generated asking a user to confirm that border 48A extends around an image of a trailer. It will be understood that virtually any suitable trailer identification may be utilized, and the present disclosure is not limited to borders 48 and 48A. At step 34, the system (vehicle) may also prompt a user to deploy the deployable structures (e.g. slide out 3C and steps 3B), and an image 47 (FIGS. 7 and 8) showing the deployable structures in the deployed configuration may be displayed on the user interface 15. The system (vehicle) may utilize image recognition to identify the deployable structures in images 47A and 47B displayed on user interface 15, and the system may be configured to identify (e.g. highlight) the detected structures in the deployed position utilizing, for example, lines 50 extending around the deployed structures. The system may be configured to prompt a user to confirm that the regions inside of the lines 50 correspond to deployable structures of trailer 2 (e.g. by touching the screen inside lines 50). It will be understood that the identification of deployed structures (e.g. FIGS. 7 and 8) may occur before or after identification of the trailer 2 (FIGS. 5-6) and storing of data corresponding to the stored (towable) configuration of FIGS. 5-6.

Referring again to FIG. 3, at step 36 the system (vehicle) may be configured to store a first (towable) form factor (e.g. database) corresponding to sensor data in which all deployable items are in their respective fully stowed positions such that the trailer can be towed. For example, the vehicle may store the stowed image 46 and/or images 46A and 46B (FIGS. 5 and 6), and store deployed image data corresponding to images 47, 47A, 47B and identify the deployed images as corresponding to at least one “deployed” or non-towable form factor or trailer configuration.

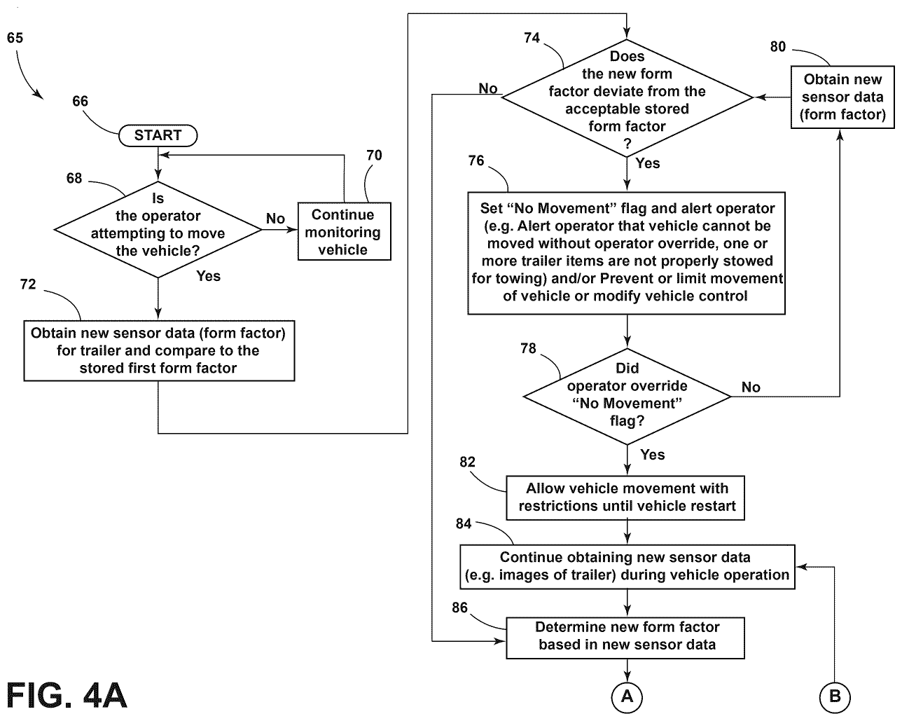

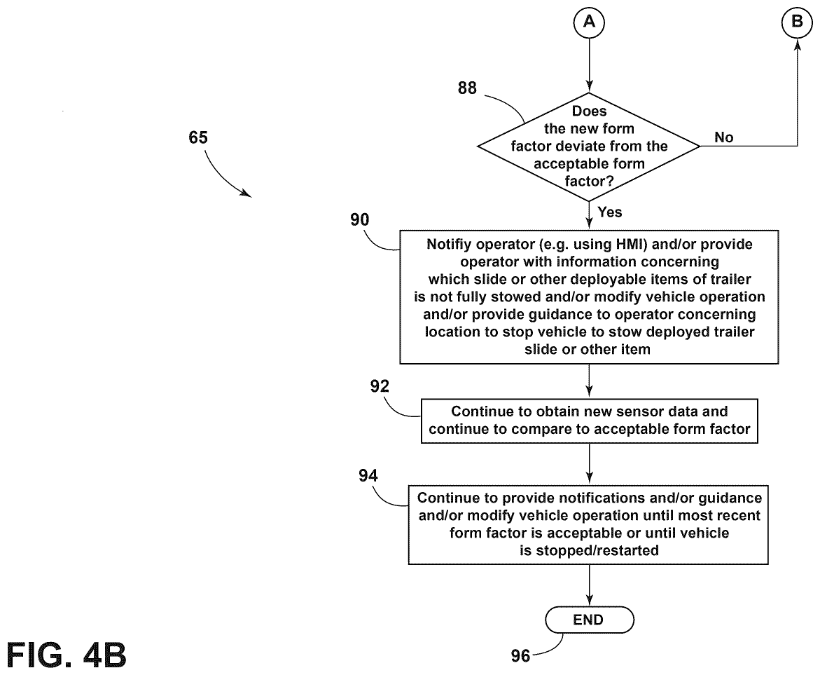

The startup process 25 of FIG. 3 may then end at step 44. As discussed in more detail below, following the end step 44 of initial setup process 25 (FIG. 3), the truck (vehicle) 1 may proceed to a start 66 of a vehicle operation process 65 (FIGS. 4A and 4B).

Referring again to FIG. 3, if the vehicle determines that the detected trailer is not a new trailer at step 30, the vehicle retrieves stored trailer data at step 38. The trailer data may comprise a profile of a trailer 2 that was previously towed by truck 1, and may include, for example, towable and non-towable trailer form factors which may comprise trailer data such as images of one or more deployable structures 3 in deployed and/or retracted positions. At step 40, the vehicle may prompt a user to update the towable and/or non-towable trailer profiles if necessary to account for changes in the configuration of the trailer. The prompt may be in the form of text and/or images displayed on the user interface 15. If updates are required, the process continues to step 32. If updates are not required at step 42, process 25 then ends at step 44.

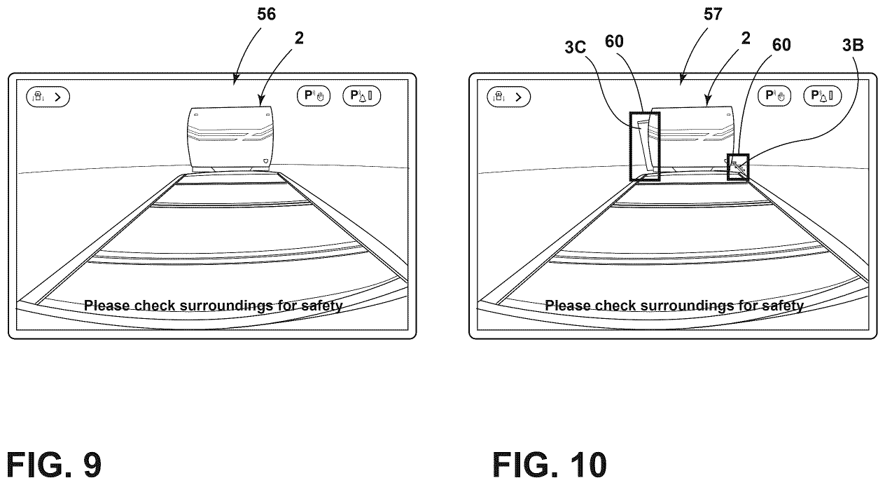

The vehicle 1 may be configured to utilize images 46 and 47 from mirror cameras 10 (or other data source) as discussed above in connection with FIG. 3 during initial trailer setup whereby a user identifies the stowed and deployed trailer configurations or form factors. However, alternative sensor inputs may also be utilized during the trailer setup process 25. For example, with reference to FIG. 9, one or more images 56 of a trailer 2 in which the deployable structures are stowed may be displayed on user interface 15. A user may be prompted to identify the trailer 2, and the user may be prompted to deploy the structures of trailer 2, and an image 57 showing the deployed structures may then be displayed on user interface 15. The system may be configured to initially identify the deployed structures utilizing, for example, lines 60, and a user may be prompted to confirm that the lines 60 identify deployable structures or features in the deployed positions (e.g. by touching the screen inside lines 60). The system may then store sensor data such as camera images 56 and 57 for a specific trailer 2.

Referring again to FIG. 1, truck 1 may include a plurality of sensors 14 that are operably connected to the control system 18, and trailer 2 may optionally include sensors 17 that are operably connected to control system 18 (e.g. wirelessly or using wires). Sensors 14 and/or 17 may comprise radar sensors for blind spot, CHMSL, backup, etc., LiDAR, ultrasonic sensors, cameras (e.g. one or more of cameras 6, 10, and 12) (360 degree cameras) or other sensors. In general, sensors 14 and/or 17 may comprise one or more known radar, LiDAR, and/or ultrasonic sensors. The sensors 14 and/or 17 may be configured to provide data to the control system 18 corresponding to the stowed and deployed configurations of the deployable structures of trailer 2. The data from these sensors may be utilized to provide an interactive input arrangement utilizing, for example, user interface 15 whereby a user may identify and/or input sensor data corresponding to stowed and deployed configurations of deployable features 3 of trailer 2. Thus, the setup process 25 of FIG. 3 is not limited to cameras or images from one or more cameras on vehicle 1 or trailer 2. Rather, other types of sensor data may be utilized to identify stowed and/or deployed configurations of the deployable structures of a trailer 2.

During operation, vehicle 1 may implement a process 65 according to FIGS. 4A and 4B. It will be understood that FIGS. 4A and 4B show different aspects of process 65, and the letters A and B in circles at the bottom of FIG. 4A and the top of FIG. 4B merely designate locations at which the arrows continue between FIGS. 4A and 4B. Process 65 may be implemented after the set up process 25 (FIG. 3).

In process 65, following start 66 vehicle operation is monitored (step 68). If the operator is not attempting to move the vehicle at step 68, the system (vehicle) continues monitoring the vehicle as shown at step 70. However, if an operator is attempting to move the vehicle at step 68, the process obtains new sensor data (e.g. camera images) for trailer 2 from the vehicle and/or trailer sensors (or other source), and compares the sensor data to the stored first form factor (towable/stowed trailer configuration). As discussed above in connection with FIG. 3, the first form factor may correspond to a trailer configuration in which all deployable structures 3 are in the stowed positions whereby the trailer 2 can be towed.

At step 74, the vehicle determines if the new form factor (e.g. camera images or other sensor data) deviates from the acceptable/towable (first) form factor. The vehicle may include data (image) recognition capabilities whereby stored trailer data/images are compared to newly obtained trailer data/images at step 74 whereby the vehicle determines if one or more of the deployable structures are not in the stowed configuration.

If the form factor does deviate from a stored acceptable/towable form factor at step 74, the process continues to step 76. Step 76 may include various user alerts and/or restrictions on vehicle movement. For example, the system may set a “No Movement” (or “Restrict Movement”) flag at step 76 and/or alert the vehicle operator that the trailer is not in a towable configuration and/or that one or more of the deployable structures of trailer 2 are deployed and/or not in the stowed positions. It will be understood that the vehicle (e.g. truck 1) does not necessarily utilize a “No Movement” (or “Restrict Movement”) flag, and this term is used to convey the general concepts associated with restricting movement of the vehicle when a deployable structure of the trailer 2 is not retracted. The system (vehicle) may, optionally, be configured such that an operator override is required to move the vehicle if trailer 2 is not presently in an acceptable state because the present form factor (trailer data) deviates from a stowed acceptable/towable form factor. For example, the vehicle may be configured to notify a user that the trailer 2 is not in a towable configuration and prompt a user to determine if an operator override is desired. If a user overrides the “No Movement” flag, the vehicle may be configured to permit full vehicle motion without restrictions related to trailer 2, or the vehicle may be configured to allow limited vehicle movement upon user override. For example, the vehicle may be configured to permit low speed movement (e.g. under 5 mph) if user override is selected. This may permit, for example, a user to move a trailer 2 while one or more deployable structures are deployed to permit adjustment of a trailer position at a campsite while slides or other items of trailer 2 are deployed.

If an operator does not override the “No Movement” flag at step 78, the vehicle obtains new sensor data at step 80, and returns to step 74. However, if an operator does override the “No Movement” flag at step 78, at step 82 the vehicle allows vehicle movement with restrictions until the vehicle is restarted.

Following step 82, the vehicle continues to obtain new sensor data (e.g. images of trailer 2) during vehicle operation, and also continues to determine and update the current or new form factor based on the new sensor data at step 86. Thus, the vehicle may be configured to continuously monitor trailer 2 during vehicle operation to detect deployment of one or more deployable structures.

At step 88, the vehicle determines if the new form factor deviates from the acceptable/towable form factor. If the form factor does not deviate at step 88, the vehicle continues obtaining new sensor data at step 84. However, if the new form factor does deviate from an acceptable form factor at step 88, the vehicle may, at step 90, generate a notification to the operator and/or provide an operator with information concerning which slide or other deployable items of the trailer are not fully stowed. The vehicle may also (optionally) modify or limit the vehicle's operation and/or provide guidance to an operator concerning a location to stop the vehicle so that the deployed trailer slide or other item can be stowed. In general, the notifications and other information provided to the operator at step 90 may be provided utilizing user interface 15 or other vehicle systems (e.g. audio system) and/or a smartphone or other device.

As shown at steps 92 and 94, during continued vehicle operation the vehicle continues to obtain new sensor data from sensors 14 and/or 17 and continues to compare the new sensor data to the stored data. The new data and stored data may comprise a new trailer form factor and a stored (acceptable) trailer form factor. As shown at step 94, the vehicle may be configured to continue to provide a notification and/or guidance and/or modify vehicle operation until the most recent form factor is acceptable or until the vehicle is stopped and/or restarted. Process 65 may end at step 96 when, for example, the vehicle is in a “key off” state.

A motor vehicle according to an aspect of the present disclosure may utilize sensor suite 14 (FIG. 1) and/or trailer sensors 17. Sensors 14 and/or 17 may include cameras (e.g. rear cameras/side view mirror cameras/CHMSL cameras), radar (blind spot CHMSL, backup, etc.), LiDAR, and/or ultrasonic sensors to determine if a trailer component (e.g. a camper slider) is deployed or becomes deployed while traveling (i.e. while the vehicle is in motion). The motor vehicle (e.g. truck 1) may include a trailer setup system/process which may include image storage and recognition of a trailer 2 with all sliders/awnings/stairs stowed. The vehicle may utilize image storage and recognition of a trailer 2 with all sliders/stairs/awnings deployed. The vehicle may be configured to store trailer profiles, and the vehicle may be configured to acquire baseline images of a trailer 2 when the trailer 2 is in a towable configuration in which no sliders or other features are deployed, and the vehicle may utilize image recognition to detect deviations in a trailer image to alert a vehicle operator and/or modify vehicle operation.

A Human Machine Interface (HMI) may be utilized, and the HMI may involve one or more of augmented reality, sketching, and/or a menu system that may be implemented utilizing a user interface such as a touch screen 19 (FIG. 2) on a vehicle interior. The HMI-based system may be utilized to identify what a trailer 2 looks like with sliders/awnings/stairs and/or other structures deployed, and a menu-driven system may be utilized to guide a user (e.g. vehicle operator) through the process of setting up the user's trailer. The system may be configured to utilize FORDPASS® or other remote/phone-based app that can be used to assist if the user/operator wants to do their trailer setup remotely or outside of their vehicle. If the vehicle/combination vehicle and trailer is parked, the vehicle may utilize the sensor suite to determine if the camper sliders/stairs/awnings are deployed. If one or more are deployed, the vehicle may be configured such that the vehicle does not shift from Park without a confirmed override by the vehicle operator.

When the vehicle (e.g. truck 1) is in motion, the vehicle may utilize the sensor suite 14 and/or trailer sensors 17 to determine if the camper sliders/stairs/awnings become deployed. If one or more of these deployable structures are deployed, the vehicle may be configured to:
Limit vehicle speed and/or reduce vehicle speed
Cancel blue cruise/control
Inform driver via HMI
Offer option to inform authorities
Modify stability control and/or sway control thresholds
Provide navigation to a location where the situation can be resolved

As discussed above, the vehicle may include an override function to permit an operator to decide to tow a trailer even though one or more items are deployed. This feature may be used to permit repositioning of a trailer on a campsite, or moving a short distance, or if the camper (trailer) is not operating properly.

Positional sensors 17 (FIG. 1) in the camper and/or trailer 2 may also be used to determine if sliders/stairs/awnings are deployed. V2X (vehicle-to-everything) camera imagery from security and other cameras at homes/campsites may also be used to determine if sliders/stairs/awnings are or become deployed.

For applications in which a trailer includes one or more devices (e.g. friction-based) to generate a negative torque tending to reduce a speed of the trailer, which devices are controlled via CAN or other communications networks, the vehicle may be configured to cause the trailer to generate a negative torque until the stairs/awnings/pop-outs are properly stowed. For campers are RVs having existing sensors for sliders/pop out features/stairs, the vehicle sensor or cameras may be utilized to provide redundancy.

As discussed above in connection with FIG. 1, a vehicle 1 according to an aspect of the present disclosure may be utilized in connection with a trailer 2 having one or more deployable features 3. However, vehicle 1 may also be configured to detect deployed features if, for example, a pickup box camper (not shown) is installed on truck 1. Truck 1 may also be configured to detect popup campers, boat trailers, and the like. In general, the vehicle (truck 1) may be configured to utilize sensors (e.g. cameras) to generate a baseline form factor and detect deviations from the baseline corresponding to one or more features of the popup camper or boat/trailer being deployed or moved from a stowed position.

Truck (vehicle) 1 may also be configured to determine if trailer doors are opening/closing/swinging, and to detect load shifting in an open trailer (not shown). Truck 1 may also be configured to detect changes in a closed trailer, movement of a boat on a trailer, loose load retention straps and/or chains outside of a trailer dimension or the confines of a trailer and/or any changes in these items. The vehicle (truck) may also be configured to detect/identify swing out type and other campers/trailers which change their configuration when in use (e.g. at a campsite). The vehicle may be configured to utilize periodic rear-facing measurements to verify that nothing has moved or shifted while the vehicle and trailer are in motion. In general, cameras or other sensors may be utilized to detect an improper trailer configuration, a change in trailer configuration, or other occurrence that may suggest a trailer is not properly configured for towing. In general, these determinations may be made before a vehicle is in operation and/or while a vehicle is in operation.

Truck 1 may also be configured to utilize one or more of cameras 6, 10, and/or 12 and image recognition/size estimation to determine if a trailer size or shape has changed due to items such as:
Boat canopy/bimini not stowed or becoming unstowed
Satellite dish on RV not stowed
Objects strapped to a trailer (e.g. ladders, kayaks, tubes) moving or being installed

Where camera-based image size estimation is not possible, HMI (either via touch screen or FORDPASS® App) may require user input to actually measure the trailer height when inputting to the trailer specs on the first-time setup (e.g. process 25, FIG. 3). Smartphone or other remote measurement mechanisms or devices may also be used.

Trailer sensors 17 may comprise interior and/or exterior trailer-based cameras and vehicle to vehicle communication that can be utilized to determine if various portions of the trailer are in their home/original positions. The trailer may be configured to reference positional sensors/binary switches for each component that can be potentially deployed on the trailer to ensure they are in their home/locked position and/or a position that indicates they will not be touching the ground/vehicle movement is allowable. Thus, a vehicle according to the present disclosure may utilize a wide range of trailer data from sensors on the vehicle and/or the trailer or other sources (e.g. cameras or other sensors on a building) to determine if the trailer is in a towable condition according to predefined criteria.

Such operations described herein should always be implemented and/or performed in accordance with the owner's manual and safety guidelines.

It is to be understood that variations and modifications can be made on the aforementioned structure without departing from the concepts of the present invention, and further it is to be understood that such concepts are intended to be covered by the following claims unless these claims by their language expressly state otherwise. For example, the present disclosure is not limited to a specific vehicle type, and “truck” is merely an example of a vehicle according to an aspect of the present disclosure. The terms “camera” and “images” are merely examples of sensors and sensor data, respectively, and the present disclosure is not limited to cameras or other specific types of sensors.

What is claimed is:

1. A motor vehicle adapted for towing a trailer having a deployable structure that extends and retracts from a side of the trailer between deployed and retracted positions, the motor vehicle comprising:
a user interface that is configured to permit a user to input information corresponding to the retracted and deployed positions of the deployable structure based, at least in part, on an image of a trailer that is generated using trailer data from a sensor; and wherein:
the vehicle is configured to: 1) utilize the trailer data to determine if the deployable structure of the trailer is at least partially deployed from the retracted position, and: 2) if the deployable structure of the trailer is at least partially deployed, generate an operator alert and/or modify vehicle operation and/or restrict movement of the vehicle.

2. The motor vehicle of claim 1, wherein:
the motor vehicle includes a sensor that is configured to capture trailer data corresponding to at least a portion of a trailer hitched to the vehicle, and wherein the vehicle is configured to utilize the trailer data captured by the sensor of the vehicle to determine if the deployable structure of the trailer is at least partially deployed from the retracted position.

3. The motor vehicle of claim 2, including:
a trailer having a sensor that is operably connected to the motor vehicle whereby the sensor communicates trailer data to the motor vehicle; and wherein:
the vehicle is configured to utilize trailer data captured by the sensor of the trailer to determine if the deployable structure of the trailer is at least partially deployed from the retracted position.

4. The motor vehicle of claim 1, wherein:
the sensor comprises a rearview camera mounted to the motor vehicle.

5. The motor vehicle of claim 2, wherein:
the motor vehicle is configured to store a first form factor corresponding to at least one set of trailer data, wherein the first form factor corresponds to a trailer configuration in which the deployable structure is not deployed.

6. The motor vehicle of claim 5, wherein:
the motor vehicle is configured to detect a trailer hitched to the vehicle, and utilize the user interface to prompt a user to identify a second form factor corresponding to a trailer configuration in which the deployable structure of the trailer is in a deployed position.

7. The motor vehicle of claim 6, wherein:
the sensor comprises a camera;
the motor vehicle is configured to use image recognition to detect deviations from the first form factor.

8. The motor vehicle of claim 5, wherein:
the motor vehicle is configured to detect deviations from the first form factor while the motor vehicle is stationary and/or while the motor vehicle is moving.

9. The motor vehicle of claim 7, wherein:
the motor vehicle is configured to, at least initially, restrict and/or prevent movement of the motor vehicle if the vehicle detects deviations from the first form factor.

10. The motor vehicle of claim 9, wherein:
the motor vehicle is configured to permit movement of the motor vehicle if a user override is activated after deviations from the first form factor are detected.

11. The vehicle of claim 1, wherein:
the user interface is configured to display an image of at least a portion of a trailer hitched to the vehicle, whereby a user can identify 1) an image of the trailer in which a deployable structure of the trailer is at least partially deployed, and/or 2) an image of the trailer in which a deployable structure of the trailer is in a retracted position.

12. The vehicle of claim 11, wherein:
the vehicle is configured to store a profile of a trailer based, at least in part, on information input by a user concerning 1) an image in which a deployable structure is at least partially deployed, and 2) an image in which a deployable structure is in a retracted position.

13. The vehicle of claim 12, wherein:
the vehicle is configured to 1) determine if a trailer is hitched to the vehicle, and 2) determine if a profile of the trailer has been stored.

14. The vehicle of claim 13, wherein:
the vehicle is configured to prompt a user to input information concerning retracted and/or deployed configurations of a deployable structure if a profile of the trailer has not been stored.

15. The vehicle of claim 13, wherein:
the vehicle is configured to retrieve a profile of the trailer if a profile of the trailer has been stored.

16. The motor vehicle of claim 1, wherein:
the vehicle is configured to restrict vehicle movement by limiting a speed of the vehicle if a deployable structure is not in the retracted position;
the vehicle includes a user override feature that permits a user to at least partially modify the restriction of vehicle movement.

17. The motor vehicle of claim 9, wherein:
the vehicle is configured to prevent movement of the vehicle if a deployable structure is not in the retracted position.

18. A motor vehicle that is capable of towing a trailer having a deployable structure, the motor vehicle comprising:
at least one sensor that is configured to capture trailer data for a trailer that is hitched to the vehicle, the trailer data including a first set of trailer data in which a deployable structure of the trailer is in a stowed position, and a second set of trailer data in which the deployable structure is in a deployed position;
a user interface;
wherein the motor vehicle is configured to utilize the user interface to communicate the trailer data to a user;
and wherein the user interface is configured to permit the user to identify the second set of trailer data as corresponding to a non-towable trailer form factor;
and wherein the vehicle is configured to utilize a data recognition feature to recognize trailer data for a trailer configuration in which a deployable structure of the trailer is not in a stowed position based, at least in part, on at least one of the first and second sets of trailer data.

19. The motor vehicle of claim 18, wherein:
the motor vehicle is configured to restrict a speed of the motor vehicle if a deviation from the first set of trailer data is detected by the motor vehicle.

20. The motor vehicle of claim 18, including:
a camera; and wherein:
at least one of the first and second sets of trailer data comprises an image of a trailer that can be displayed on the user interface.
